(19) United States
(12) Patent Application Publication
(10) Pub. No.: US 2026/0352697 A1
(43) Pub. Date: Nov. 5, 2026

(54) PATH CLASSIFICATION IN SECURITY GRAPH USING A COMBINATION OF MULTIPLE COLORING SYSTEMS

(71) Applicant: MICROSOFT TECHNOLOGY LICENSING, LLC, Redmond, WA (US)

(72) Inventors: Andrey KARPOVSKY, Kiryat Motzkin (IL); Amir PIROGOVSKY, Holon (IL); Chen LAHAV, Givatayim (IL); Tamer SALMAN, Haifa (IL); Lital BADASH, Herzelia (IL); Yotam Dan FEITELSON, Herzelia (IL)

(21) Appl. No.: 19/078,233

(22) Filed: Mar. 12, 2025

(51) Int. Cl. H04L 9/40

(52) U.S. Cl. CPC H04L 63/1441; H04L 63/1433

(57) ABSTRACT

Disclosed are techniques for distinguishing business legitimate connections between computing resources from suspicious connections. Making this distinction enables security threats to be mitigated without disrupting business processes. In some configurations, a collection of computing resources is modeled with a resource graph. Multiple overlapping coloring systems are applied to the resource graph. Each coloring system colors a subset of related nodes based on defined criteria. Paths through the resource graph are ranked based on how many different coloring systems show the path beginning and ending with different colors. Paths that begin and end with different colors represent connections between computing devices that are less frequent, and therefore more likely to be potentially malicious. A security operation may be performed on a computing device represented by a node of a suspicious path.

### BACKGROUND

Centralizing the provisioning and management of computing resources reduces costs and improves availability. At the same time, a concentration of computing resources also makes an inviting target for cyberattacks. Attacks often begin by gaining access to a single computing device. From this foothold, additional privileges, tokens, and other means of access are obtained, enabling the attack to continue to other devices. One strategy for limiting cyberattacks is to distinguish suspicious connections between computing resources from legitimate paths between computing resources.

It is with respect to these and other considerations that the disclosure made herein is presented.

### SUMMARY

Disclosed are techniques for distinguishing business legitimate connections between computing resources from suspicious connections between computing resources. Making this distinction enables security threats to be mitigated without disrupting legitimate business processes. In some configurations, a collection of computing resources is modeled with a resource graph in which computing resources are represented by nodes while connections between computing resources are represented by edges. Multiple overlapping coloring systems are applied to the resource graph. Each coloring system colors a subset of related nodes based on a defined criteria. For example, a coloring system representing product groups may color nodes according to the product group they are associated with, while a coloring system representing a number of enabled security features may color nodes according to whether a threshold number of security features are enabled. Paths through the resource graph are ranked based on how many different coloring systems show the path beginning and ending with different colors. Paths that begin and end with the same color for a given coloring system are deemed less suspicious, as this activity reflects expected interactions between computing devices. Paths that begin and end at different colors, in contrast, represent connections between computing devices that are less frequent, and therefore more likely to be malicious. Analyzing paths in multiple coloring systems improves the accuracy of the prediction-a path that crosses colors in multiple coloring systems is more likely to be suspicious than a path that only crosses colors in one coloring system.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates applying category criteria to nodes of a resource graph.

FIG. 1B illustrates computing an aggregate coloring system score for a path through a resource graph and selectively applying a security operation to a computing resource associated with the path.

FIG. 1C illustrates an example path of a resource graph consisting of two nodes connected by an edge.

FIG. 2A illustrates a resource graph.

FIG. 2B illustrates three categories of an organization-based coloring system and cross-color paths between them.

FIG. 2C illustrates three categories of a development environment-based coloring system and cross-color paths between them.

FIG. 2D illustrates two categories of a security hardening-based coloring system and cross-color paths between them.

FIG. 3 is a flow diagram of an example method for Path Classification in Security Graph Using a Combination of Multiple Coloring Systems.

FIG. 4 is a computer architecture diagram illustrating an illustrative computer hardware and software architecture for a computing system capable of implementing aspects of the techniques and technologies presented herein.

### DETAILED DESCRIPTION

One technique used when protecting a collection of computing resources is to classify paths between resources. Path classification in this context refers to identifying and categorizing the paths into meaningful categories, such as business legitimate versus suspicious. Suspicious paths are more likely to be used as part of a cyberattack, while legitimate paths are more likely to be used by normal business processes.

Traditional methods of path classification are often insufficient, particularly as cyberattacks become more sophisticated and collections of computing resources become more complex. Conventional techniques often rely on single-logic rule-based classifications that do not capture the complexity of modern networks. As a result, conventional path classification techniques provide low accuracy-identifying too many legitimate paths as suspicious while also identifying too few actually suspicious paths. Existing techniques also take too long to validate and apply, and as such are ineffective against the ever-increasing number of new attacks.

Resource graphs, such as security graphs, represent organizational connectivity. For example, a resource graph may represent access permissions between entities and assets, such as which users are able to access which servers and applications. Paths over the resource graph represent possible connections between computing resources. During an attack these paths may be used as lateral attack steps, allowing an attack to spread from one resource to another.

In some configurations, resource graph paths are classified by partitioning the graph into multiple overlapping coloring systems, where each coloring system highlights different types of relationships between computing resources. Example coloring systems include environment types, business units, and a level or number of security features. An environment types coloring system may label nodes according to whether the corresponding computing resources are part of a production environment, a test environment, or a development environment. A number of security features coloring system may label nodes according to how many security features the corresponding computing resources have enabled. Some coloring systems color nodes based on a dynamic analysis of the resource graph, such as coloring nodes based on how frequently they communicate with particular nodes.

Paths that cross colors within a given coloring system are considered more suspicious than single-color paths. Paths that begin and end with different colors are considered more suspicious than paths that begin with one color, cross into another color, and then cross back to the original color. Paths that begin in a coloring systems but end outside of that coloring system may be considered even more suspicious than paths that begin and end in different colors of a given coloring system. Single-color paths are considered non-suspicious.

Analyzing the resource graph in multiple dimensions allows particularly suspicious paths—paths that cross colors in multiple coloring systems—to be highlighted. The improved accuracy of the disclosed embodiments allows potential attacks to be prevented and ongoing attacks to be disrupted while not overly interfering with business processes.

The disclosed techniques may leverage graph theory principles to label nodes with colors, discover paths, and identify suspicious cross-color paths. A coloring system in graph theory is an assignment of labels traditionally called “colors” to nodes of a graph, subject to certain constraints. In a special case called ‘proper coloring’ the constraint is that adjacent nodes must have different colors. However, other types of coloring are possible, such as subcoloring and cocoloring. As used herein, a coloring system represents a meaningful partition of nodes to types, and adjacent nodes may be labeled with the same color.

In some configurations a security operation is performed on a suspicious path or on one or more nodes of the suspicious path. Some security operations report suspicious paths to a system administrator, such as sending a security alert that describes the suspicious path and identifies it as a possible vector for attack. This aids in decision-making and prioritization of network security measures. Other security operations automatically mitigate poor security posture or disrupt an ongoing attack. For example, a security feature may be automatically enabled, of an already active security feature may be increased in intensity or level. The disclosed embodiments may also be used retrospectively as part of an investigation into how an attacker was able to compromise a particular computing resource.

Cross-color paths-paths that begin and end with different colors of a particular coloring system, are suggestive of a “bad” security practice, or may be an indication of an ongoing attack. For example, connections between production and non-production assets are generally not allowed. In a cloud computing environment, connections between tenants is also not generally allowed. Furthermore, computing resources that communicate very rarely, or that have different security configurations are also suspicious. In some configurations, different organizations may elect to apply different coloring systems and/or customize the threshold at which a path is considered suspicious.

Most signals generated by individual coloring systems are weakly predictive of potential misuse, and in many cases there is a legitimate explanation for a cross-color connection. Path classification is improved by aggregating the analysis of multiple coloring systems. Paths within a resource graph are evaluated based on multiple coloring systems, providing a multi-dimensional view of the network's security posture. The result is a more accurate path classification and an increase in the number of paths that are suspicious enough to be actionable. In some configurations, a path is considered more suspicious for each additional coloring system in which it crosses colors. For example, a path connecting a non-production asset in one subscription and which has disabled security features to a production asset in another subscription and which has enabled many security features might be considered very suspicious due to the path crossing three color boundaries.

In some configurations, the accuracy of path classification is further improved based on an analysis of higher-level patterns. Instances of higher-level patterns may be analyzed to determine whether they cross colors, similar to the analysis of individual paths. One pattern is color alignment across coloring systems, in which nodes that tend to have one color in one coloring system also have a specific other color in another coloring system. If the frequency of a pattern is high enough, the pattern may be considered a reflection of a legitimate business practice, and so paths that make up the pattern may be considered less suspicious than identical paths that are not part of the observed pattern. Additionally, or alternatively, the pattern may be reflective of a pervasive security issue or an ongoing attack. Another pattern is a hierarchical relationship in which paths that begin with various colors of a coloring system tend to end with a particular color of that coloring system, reflecting many child nodes having a single parent node. A hierarchy of nodes may be considered more or less suspicious in different contexts. Thresholds that determine when a pattern exists can be customized, e.g., what percentage of paths that begin with various colors have to end with a particular color to be considered part of a hierarchy.

Analyzing higher-level patterns allows multiple paths to be evaluated as a unit, potentially reducing the number of security operations that are performed. For example, if at least a defined percentage of development environment to test environment color crossings also cross from various subscriptions to a specific target subscription, this might be considered a single scenario for investigation instead of analyzing and potentially reporting on each individual cross-color path.

The disclosed embodiments accurately find insecure graph patterns, explain them, and suggest or automatically perform mitigations. In addition to improved accuracy, the combination of multiple coloring systems for path classification offers a number of additional benefits, such as enhanced visibility and explainability, tailored security measures, and scalability and flexibility.

Accuracy is improved by controlled optimization of recall vs precision. Recall refers to the ability to find actually suspicious paths, while precision refers to the ability to avoid incorrectly identifying a legitimate path as suspicious. The desired balance of recall vs precision may be found by selecting the coloring systems and configuring thresholds and other criteria of the selected coloring systems.

Visibility and explainability is enhanced by providing a detailed view of the network's structure and behavior. This enables proactive identification of security risks with clear explanations. Security measures may be tailored based on the specific characteristics of the paths that are identified as suspicious.

Security measures may be tailored by selecting a disruption or other measure based on the particular pattern of nodes in the suspicious path/pattern. Security measures may also be tailored according to an organization-provided precondition. For example, an organization may specify in a machine-readable configuration that no connections are allowed between production and non-production environments. When such a connection is found, an organization-specified response of proactively disrupting the connection may be taken automatically or within a defined amount of time. Additionally, or alternatively, an alert may be sent that identifies the computing resources that violate the precondition.

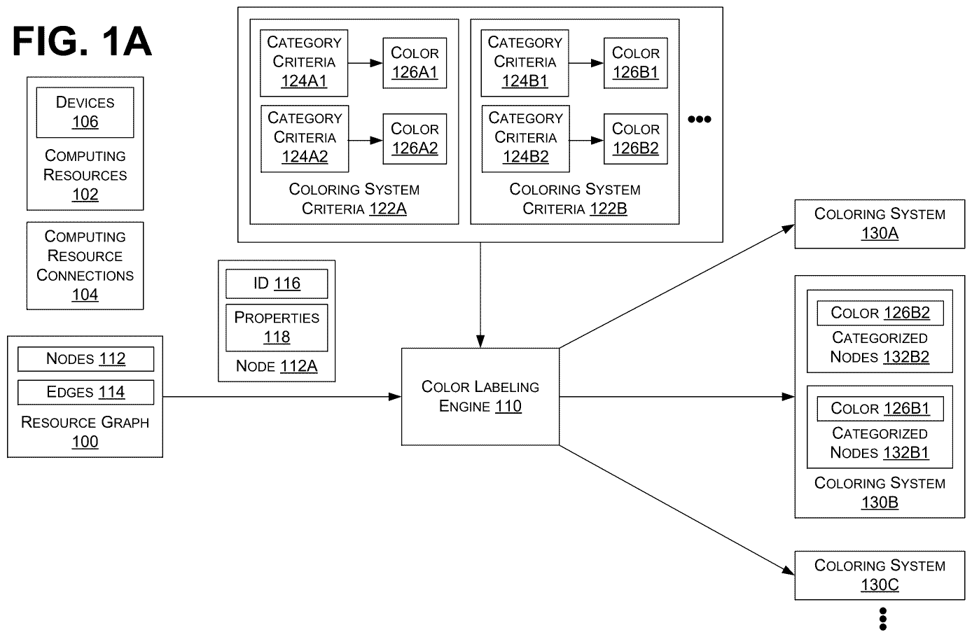

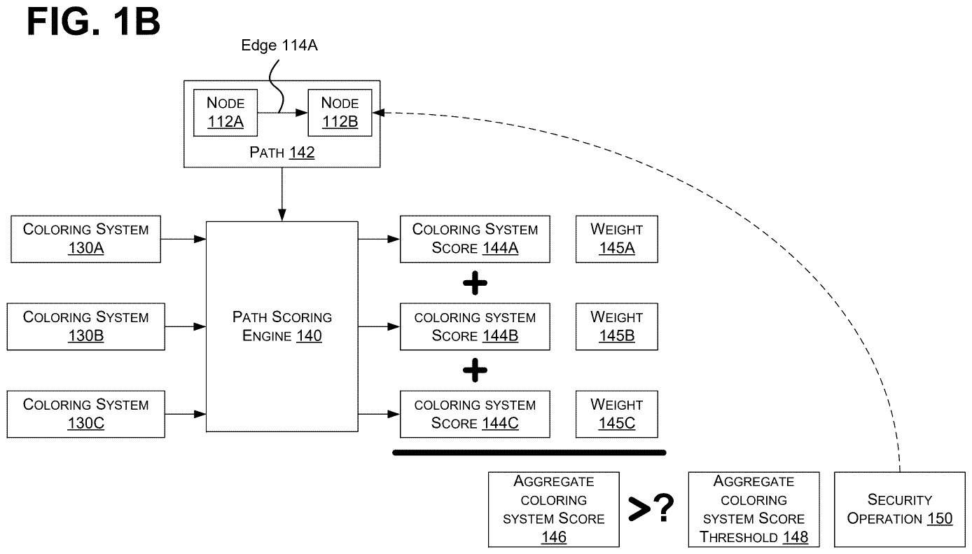

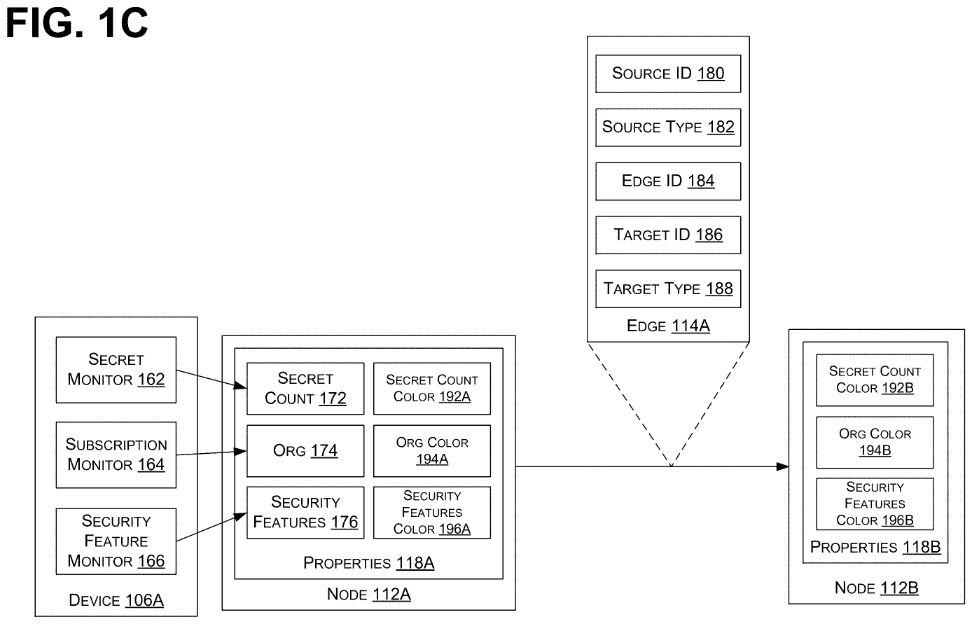

FIG. 1A illustrates applying category criteria to nodes of a resource graph. Resource graph 100 includes nodes 112 and edges 114. Nodes 112 represent computing resources 102, while edges 114 represent computing resource connections 104 between computing resources 102. Computing resources 102 is a collection of entities that represent computing devices and the concepts used to manage and access them. For example, computing resources 102 may include devices 106 such as physical computing devices, routers and other networking infrastructure, storage devices, databases, etc. Computing resources 102 may also include virtual machines, managed storage services such as table-based and object-based storage services, and other virtual devices and managed services. Computing resources 102 may also include authentication and authorization information such as user identification, user groups, access tokens such as SSH tokens, etc.

Computing resources 102 may also include information obtained from external sources such as threat intelligence. Threat intelligence indicates an observation about another computing resource, such as a level of security measures that have been applied to a computing device. Threat intelligence may also include, for example, a list of IP addresses suspected of being controlled by malicious actors, a list of other computing resources 102 that have performed actions consistent with a cyberattack, etc.

Computing resources 102 may represent any collection of computing resources, such as an on-premises collection of computing devices of a particular company or cloud computing infrastructure that is shared by multiple customers. Computing resource connections 104 represent how computing resources 102 connect, communicate, or interact with one another. For example, computing resource connections 104 may represent data flows between devices 106—such as how a computing device backs up data to a backup service. Computing resource connections 104 may also represent how a user of one of devices 106 may gain access to another one of devices 106. Computing resource connections may also represent how authentication and authorization information may be used to gain access to a computing device.

Nodes 114 may include node identifier 116 and properties 118. Node identifier 116 may be any unique identifier, such as a unique number or a globally unique identifier. Properties 118 may include name-value pairs, a hierarchy of properties, or other arrangement or configuration of information about a particular node. Properties 118 may be set explicitly by a user or administrator, such as indicating which environment of a software development cycle a computing device is part of. Properties 118 may also be obtained dynamically, such as by monitor programs running on computing devices 106. For example, a monitor may report which user identifiers have been used to access a computing device, adding this information as one or more properties 118 of the corresponding node 112. Properties 118 may be text-based or numeric, strongly or weakly typed, and immutable or updatable. In some configurations, individual properties 118 follow one or more templates or other predefined structures, while other properties are defined by the monitor programs and other sources without adhering to a predefined structure.

Resource graph 100 is provided to color labeling engine 110 with a number of coloring system criteria 122. Coloring a node refers to labeling the node with an identifier that associates it with other nodes of the same color 126. As referred to herein, a coloring system 130 is a collection of nodes 112 that are related in at least one dimension. For example, coloring system 130 may include nodes that are related by device type, cloud customer, installed software, enabled security features, software development cycle environment such as development, test, and production environments, stored content type such as whether a node stores private user data, business unit within an organization such as accounting, HR, research, or particular product groups, etc.

Each coloring system system 130 includes multiple categorized nodes 132, each of which is associated with a different color 126. Categorized nodes 132 are collections of nodes 112 that have been colored according to a category criteria 124 of a corresponding coloring system criteria 122. For example, color labeling engine 110 may generate coloring system 130B by applying coloring system criteria 122B to nodes 112. Categorized nodes 132B are identified by applying category criteria 124B of coloring system criteria 122B to nodes 112. Individual nodes 112 often appear in different coloring systems, and as such may be assigned multiple colors 126.

Coloring system criteria 122 determines how to identify and color nodes 112. In some configurations, coloring system criteria 122 identifies related nodes of nodes 112 before applying category criteria 124 to assign specific colors 126 to specific nodes 112. For example, coloring system criteria 122B describes values of one or more properties 118 that determine whether to include a particular node in coloring system 130B. For instance, coloring system criteria 122B may color nodes according to business unit, in which case coloring system criteria 122B may first apply a criteria that selects nodes of nodes 112 with properties 118 that are indicative of being part of a business unit.

Two or more category criteria 124B may then be applied to categorize and assign colors 126B to nodes 112 of coloring system 130B. Each category criteria 124B, such as category criteria 124B1, refers to a set of rules or conditions used to categorize and assign a specific color, such as color 126B1, to specific nodes 112 based on their properties 118. For example, category criteria 124B1 may assign color 126B1 to a node if one or more properties 118 of that node match or are within a defined range of a defined value. Category criteria 124B1 may also compare values to combinations of properties 118 of a node, apply nested comparisons, Boolean logic, hierarchical comparisons, or similar techniques for determining that a node of nodes 112 meets category criteria 124B1. Continuing the example, category criteria 124B1 may identify nodes that are part of a sales team business unit, while category criteria 124B2 may identify nodes that are part of a production team business unit.

Nodes of nodes 112 that meet a category criteria 124 are colored with a corresponding color 126. Color 126 is a label that distinguishes one category of nodes from another. Colors 126 may be added to properties 118 of a given node. Categorized nodes 132 refer to all of the nodes of the same color 126 of a given coloring system 130. For example, if color 126B1 is red, any nodes that meet category criteria 124B1 are colored red and constitute categorized nodes 132B1. Similarly, if color 126B2 is green, any nodes that meet category criteria 124B2 are colored green and constitute categorized nodes 132B2. In some configurations, different shades of the same color are assigned to different categorized nodes 132 of a particular coloring system 130. For example, dark blue may be assigned to categorized nodes 132B1 and light blue to categorized nodes 132B2, while categorized nodes 132A may be assigned different shades of red.

In other configurations, category criteria 124 are applied to nodes 112 directly, without first identifying the nodes 112 of the different coloring systems 130. For example, if coloring system criteria 122B colors nodes based on a software development cycle environment, various category criteria 124B may be applied to nodes 112 directly. For instance, category criteria 124B1 may identify nodes of nodes 112 that are associated with a development environment, while category criteria 124B2 may identify nodes of nodes 112 that are associated with a production environment. Some of nodes 112 will not meet any of category criteria 124B, and as such will not appear as part of coloring system 130B.

FIG. 1B illustrates computing an aggregate coloring system score for a path through a resource graph and selectively applying a security operation to a node associated with the path. Path scoring engine 140 receives or otherwise has access to coloring systems 130, including each collection of categorized nodes 132 that have been assigned one or more colors 126. Path scoring engine 140 receives or generates path 142, a path through two or more nodes 112 of resource graph 100 via one or more edges 114 of resource graph 100. As illustrated, path 142 begins at node 112A, which is connected via edge 114A to node 112B.

Path scoring engine 140 analyzes path 142 with coloring systems 130 to compute coloring system scores 144. Coloring system score 144 is a numeric representation of how suspicious path 142 is with respect to a particular coloring system 130. In some configurations, path scoring engine 140 determines whether beginning node 112A and ending node 112B of path 142 have the same color 126. Paths 142 that begin and end with the same color 126 may be considered less suspicious, resulting in a lower coloring system score 144. Paths 142 that begin and end with different colors 126 are considered more suspicious, and as such receive higher coloring system scores 144. Colors 126 may be considered different if they vary in any way, such as having different Red Green Blue (RGB) values, different alpha values, different shades, or the like.

In some configurations, paths 142 that begin and end with nodes of the same color 126 are assigned a coloring system score 144 of 1 while paths 142 that begin and end with nodes of different colors 126 are assigned a coloring system score 144 of 0, although any other combination of values are similarly contemplated. In some configurations, coloring system scores 144 may be assigned higher values when path 142 experiences additional color changes. For example, a path 142 that begins with a first color, proceeds to a second color, and then ends with a third color may be assigned a coloring system score 144 of 2. Furthermore, coloring system scores 144 of different coloring systems 130 may be weighted differently according to weights 145, allowing the influence of particular coloring systems 130 to be exaggerated or diminished relative to other coloring systems 130. For example, coloring system scores 144 may be multiplied by weights 145 before being aggregated into aggregate coloring system score 146. The values discussed here are examples, and any other values or types of values may be generated by path scoring engine 140.

Path scoring engine 140 often analyzes path 142 with multiple coloring systems 130, resulting in multiple coloring system scores 144. In some configurations, each coloring system 130 is analyzed independently. The multiple coloring system scores 144 are then aggregated into aggregate coloring score system 146 using a conjunction function.

In some configurations the conjunction function directly adds the coloring system scores 144. In other configurations, coloring system scores are multiplied or combined using a logarithmic or sigmoid-based combination. In some configurations, different coloring systems scores 144 are weighted differently, such as by multiplying coloring system scores 144 with weights 145 before being aggregated by the conjunction function. For example, a contribution of a coloring system score 144A for a coloring system 130A that categorizes nodes based on development cycle environment may have a weight 145A of 70% applied, while a contribution of a coloring system score 144B for a business unit may be more indicative of a suspicious path, and so have a weight 145B of 150% applied.

In some configurations, the conjunction function applies weights to coloring system scores 144 based which other coloring systems 130 path 142 crosses colors. For example, path scoring engine 140 may apply more or less weight to coloring system score 144B of a business unit coloring system 130B when the same path 142 is also cross-colored for a cloud customer coloring system 130C.

Some paths 142 consist of two nodes 112 connected by a single edge 114. However, paths may be longer, comprising three or more nodes 112 and two or more edges 114. Longer paths may be evaluated as a single long path or broken down into single-edge paths for evaluation.

For a given coloring system 130, path 142 may include uncolored nodes-nodes that are not part of any collection of categorized nodes 132. For example, a coloring system 130 that pertains to business units may not categorize user identifiers, tokens, or other security related nodes as part of any particular business unit.

Aggregate coloring system score 146 may be compared to aggregate coloring system score threshold 148-referred to herein as threshold 148-to determine whether and which security operation 150 to perform. Threshold 148 may be a value that has been observed over time to strike a correct balance between overly intrusive application of security operations 150 and too lax of a standard that allows too many cyberattacks to occur.

In some configurations, different thresholds 148 may be applied to aggregate coloring system score 146 to determine which security operation 150 to perform. Examples of security operation 150 include notifying a user or a system administrator of a suspicious path 142, disrupting path 142 by removing a connection between computing resources, or by turning on or increasing an existing security measure. For example, security operation 150 may turn on multi-factor authentication for node 112B-one of the nodes of path 142 that has an aggregate coloring system score 146 that exceeds threshold 148 and which, by the nature of being an end node, may be compromised during an attack.

In some configurations, security operation 150 identifies a specific security threat to one or more nodes 112, such as a virtual machine being connected to a storage account with an SSH key. Additionally, or alternatively, security operation 150 may include a suggested mitigation technique, such as rotating or cancelling the SSH key. In some scenarios, security operation 150 may automatically perform the suggested mitigation technique, either immediately, or after a defined period of time. For example, security operation 150 may send a message to a system administrator recommending rotating an SSH key, and if the operation is not performed within 24 hours, automatically rotating the SSH key.

FIG. 1C illustrates an example path of a resource graph consisting of two nodes connected by an edge. Node 112A is illustrated with properties 118A, including secrete count 172, organization 174, and security features 176. Secret count property 172 is updated by secret monitor 162, a program running on device 106A that dynamically tracks how many secrets device 106A stores, such as a number of private keys, login credentials, etc. Organization property 174 is updated by subscription monitor 164, a program running on device 106A that dynamically determines which organization device 106A is a part of. Similarly, security features property 176 is updated by security feature monitor 166, a program running on device 106A that dynamically determines which security features are enabled on device 106A. Node 112A is connected to node 112B via edge 114A. Nodes 112A and 112B include properties such as secret count color 192, organization color 194, and security features color 196. These colors are assigned by path scoring engine 140 according to three different coloring systems 130.

Edge 114A includes source identifier 180, source type 182, edge identifier 184, target identifier 186, and target type 188. Source identifier 180 and target identifier 186 are identifiers that refer to nodes 112A and 112B, respectively. Source type 182 and target type 188 similarly refer to the types of nodes 112A and 112B, respectively, such as whether a node refers to a computing device, a user identifier, threat intelligence, or the like. Edge identifier 184 is a unique identifier associated with edge 114A.

Secret count color 192A stores a color 126 assigned to node 112A by a secret count coloring system 130 according to the number of secrets that secret monitor 162 has stored in secret count 172. Similarly, secret count color 192B stores a color 126 assigned to node 112B by a coloring system 130 according to how many secrets are stored on the device represented by node 112B.

Organization color 194A stores a color 126 that was assigned to node 112A based on the organization that device 106A is a part of. Similarly, security features color 196A stores a color to node 112A based on a metric of security measures that are active on device 106A. Organization color 194B and security features color 196B list corresponding colors assigned to the computing device associated with node 112B.

As mentioned briefly above, device 106A includes monitors 162, 164, and 166 gathering information used to set properties 118A of node 112A. Secret monitor 162 may monitor device 106A for indication of a security token, such as an SSH token, or a user login token. In some configurations a number of secrets found on device 106A reflected in secret count 172, one of properties 118A of node 112A.

Similarly, subscription monitor 164 is a program that monitors device 106A for which customer subscription device 106A is part of. In this context, a subscription refers to a collection of cloud computing resources associated with a particular entity or sub-entity, such as a particular organization or a particular product group within an organization. As illustrated, subscription monitor 164 sets the organization property 174 of properties 118A with the name, subscription identifier, or other indication of a subscription.

Security feature monitor 166 is a program that monitors which security features are enabled for device 106A. For example, security feature monitor 166 may note whether or not multi-factor authentication is required to access device 106A. The features detected as enabled by security feature monitor 166 may be reflected in security features 176 of properties 118A. Security features 176 may list the enabled features, count the enabled features, perform a weighted count of security features, etc.

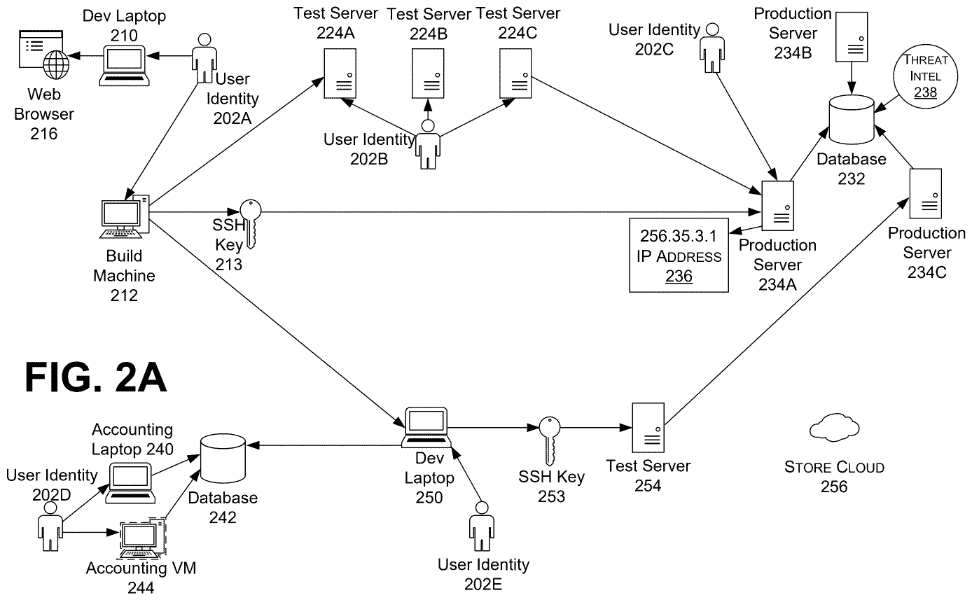

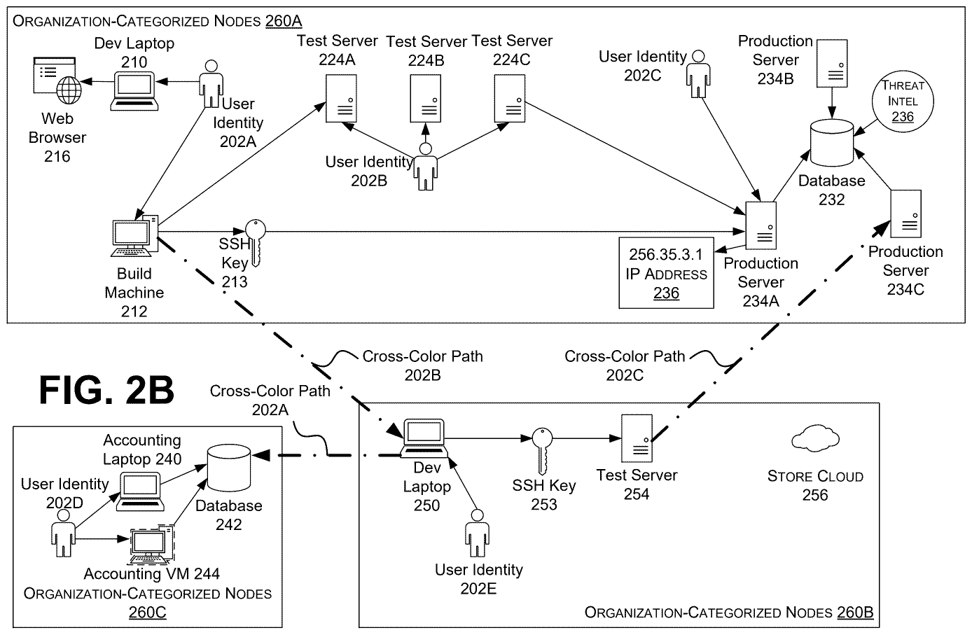

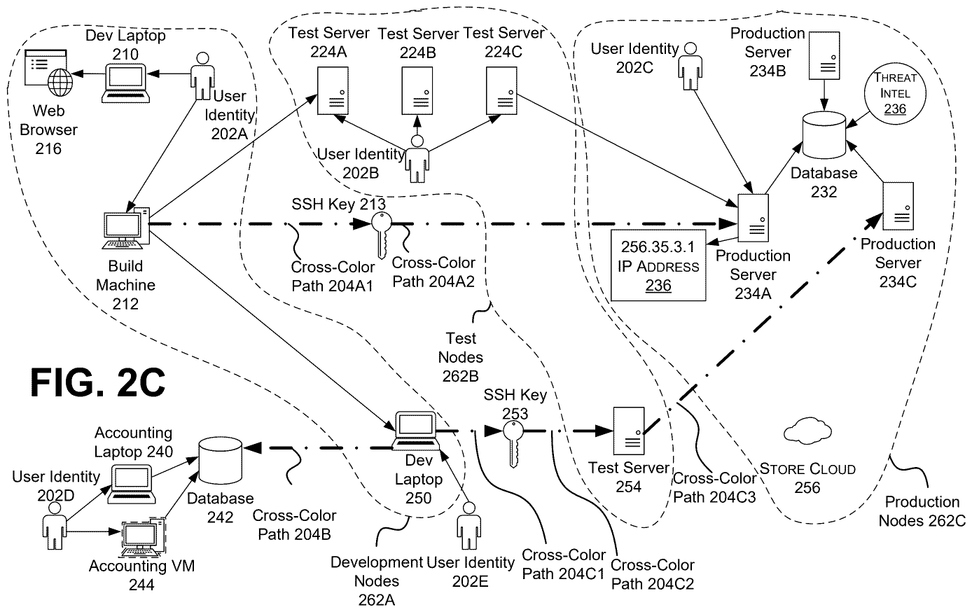

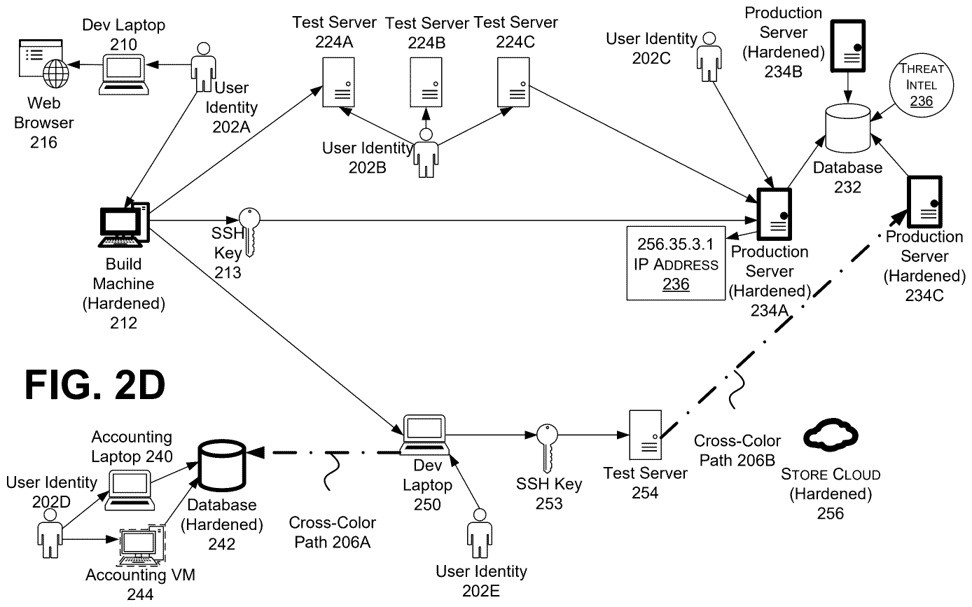

FIG. 2A illustrates a resource graph. Illustrated are nodes 112 connected by edges 114. Nodes include user identity 202A, which represents a user login or other credentials that grant access to dev laptop 210 and build machine 212. Web browser 216 illustrates that dev laptop 210 has a web browser installed. Build machine 212 is illustrated as having the ability to connect with test server 224A, dev laptop 250, and production server 234A via SSH key 213.

User identity 202B can be used to access test servers 224, while user identity 202C can be used to access production server 234A, user identity 202D can be used to access accounting laptop 240 and accounting virtual machine 244, and user identity 202E can be used to access dev laptop 250. Other connections between nodes also indicate the ability to gain access to a device. For example, test server 224C can be used to gain access to production server 234A, while dev laptop can gain access to test server 254 via SSH key 253.

FIG. 2A also depicts databases 232 and 242. Databases may be relational databases or “NoSQL” databases. Database 232 is accessible by production servers 234, while database 242 is accessible by accounting laptop 240 and accounting virtual machine 244.

Additional nodes depicted include IP address 236, which is the IP address of production server 234A. Store cloud 256 refers to a cloud-hosted service usable to store data. Threat intelligence 238 represents information about database 232, such as an unusual amount of access, execution of operations that are consistent with a cyberattack, or other information about the security posture of database 232.

FIG. 2B illustrates three categories of an organization-based coloring system and cross-color paths between them. Organization-categorized nodes 260A represent nodes that are associated with a first product group, while organization-categorized nodes 260B represent nodes that are associated with a second product group and organization-categorized nodes 260C represents nodes that are associated with the accounting department.

Cross-color path 202A illustrates a connection between dev laptop 250, part of the second product group, and database 242, which is associated with the accounting department. Cross-color path 202B illustrates a connection between build machine 212 of the first product group and dev laptop 250 of the second product group. Together these paths may form a path from build machine 212 and database 242. Cross-color path 202C illustrates a cross-color connection between test server 254 of the second product group and production server 234C of the first product group. As illustrated above in conjunction with FIG. 1A, a coloring system score 144 may be computed for this organization-based coloring system by assigning a score of ‘1’ for each of the paths 202A, 202B, and 202C.

FIG. 2C illustrates three categories of a development environment-based coloring system and cross-color paths between them. Development-categorized nodes 262A represent nodes that are associated with programming a software product, while test-categorized nodes 262B represent nodes that are associated with testing the software product and production-categorized nodes 262C represent nodes that are associated with running the software product.

Cross-color paths 204A1 and 204A2 connect build machine 212 to production server via SSH key 213. Cross-color path 204B connects dev laptop 250 to database 242. This is the same as path 202A, which also connected dev laptop 250 and database 242. As such, for coloring systems 130 that assign a coloring system score 144 of ‘1’ for any cross-color path, and for a conjunction function that adds together the coloring system scores 144 from different coloring systems 130 for a given path 142, the path between dev laptop 250 and database 242 now has an aggregate coloring system score 146 of ‘2’.

FIG. 2D illustrates two categories of a security hardening-based coloring system and cross-color paths between them. Production servers 234, store cloud 256, and database 242 are categorized as having enhanced, increased, or otherwise better security features compared to a defined security feature threshold. Accordingly, cross-color paths 206A and 206B are indicative of connections from a computing resource 102 with a lower level of security to a computing resource 102 with a higher level of security. Cross-color path 206A also connects dev laptop 250 and database 242, further increasing the aggregate coloring system score 146 of the path between dev laptop 250 and database 242.

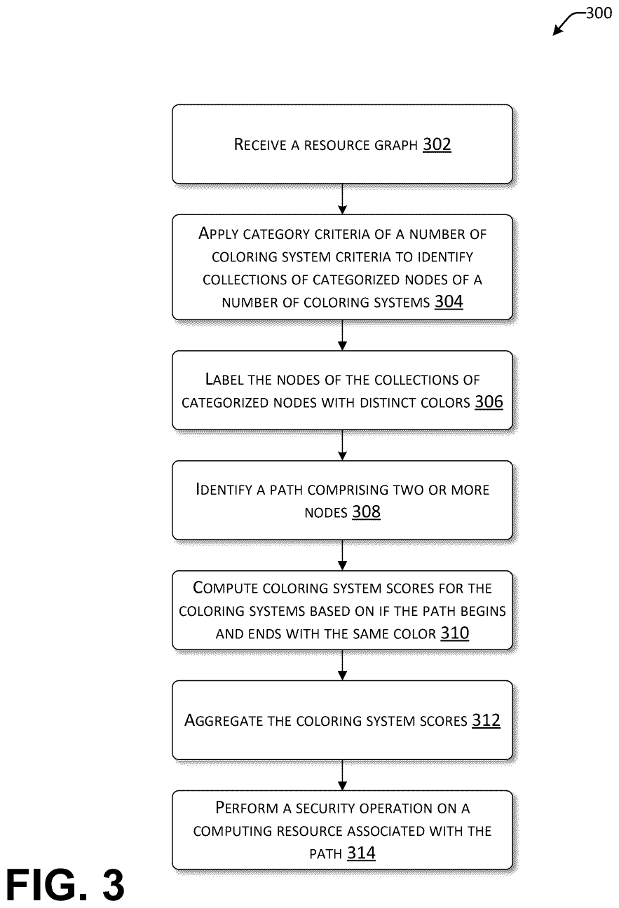

With reference to FIG. 3, routine 300 begins at operation 302, where resource graph 100 is received. Resource graph 100 may represent corporate computing infrastructure, cloud computing infrastructure, or any other collection of computing devices that are accessible to one another.

Next at operation 304, a number of category criteria 124 of a number of coloring system criteria 122 are applied to nodes 112 of resource graph 100. In some configurations, each coloring system criteria 122 has a number of category criteria 124 associated with it. A corresponding number of collections of categorized nodes 132 of a number of coloring systems 130 are identified.

Next at operation 306, nodes of the categorized nodes 134 are labeled with distinct colors 126. In some configurations, colors 126 are distinct when they are different than any other color 126 that appears in the same coloring system 130. In other configurations, colors 126 are distinct when they are different than any other color 126 that appears in any coloring system 130. In some configurations, individual coloring systems 130 apply different shades of a single color 126, such as dark blue, light blue, and sky blue, while in other configurations colors 126 are selected to be applied to different categorized nodes 132 at random.

Next at operation 308, path 142 comprising two or more nodes 112 is identified.

Next at operation 310, coloring system scores 144 are computed for path 142 for one or more of coloring systems 130. In some configurations, coloring system scores are given a defined value, such as ‘1’, when path 142 begins and ends with different colored nodes for a given coloring system 130.

Next at operation 312, coloring system scores 144 are aggregated by applying a conjunction function to compute aggregate coloring system score 146.

Next at operation 314, aggregate coloring system score 146 is compared to threshold 148, and when threshold 148 is exceeded, security operation 150 is performed on path 142 or a computing resource 102 that is associated with path 142.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 300 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 300 may be also implemented in many other ways. For example, the routine 300 may be implemented, at least in part, by a processor of another remote computer or a local circuit. In addition, one or more of the operations of the routine 300 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

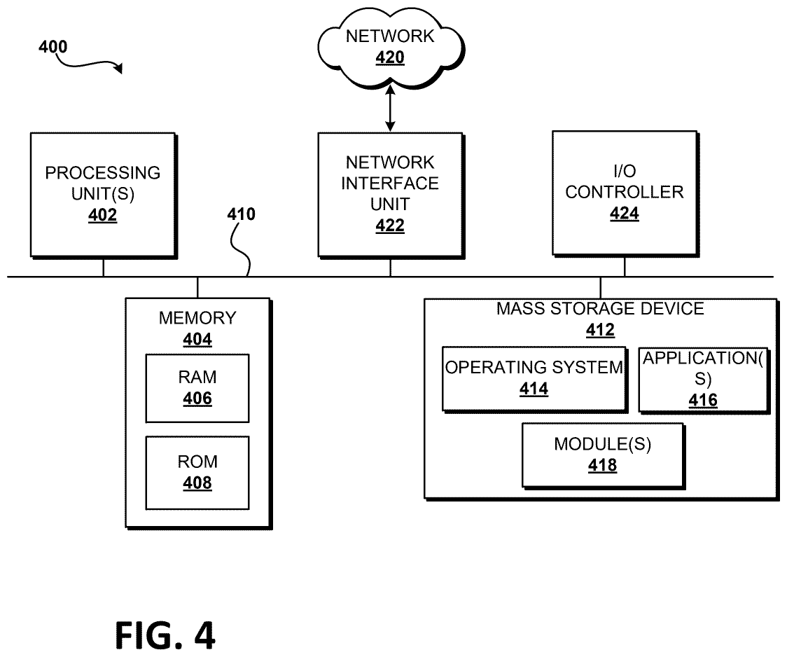

FIG. 4 shows additional details of an example computer architecture 400 for a device, such as a computer or a server configured as part of the systems described herein, capable of executing computer instructions (e.g., a module or a program component described herein). The computer architecture 400 illustrated in FIG. 4 includes processing unit(s) 402, a system memory 404, including a random-access memory 406 (“RAM”) and a read-only memory (“ROM”) 408, and a system bus 410 that couples the memory 404 to the processing unit(s) 402.

Processing unit(s), such as processing unit(s) 402, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 400, such as during startup, is stored in the ROM 408. The computer architecture 400 further includes a mass storage device 412 for storing an operating system 414, application(s) 416, modules 418, and other data described herein.

The mass storage device 412 is connected to processing unit(s) 402 through a mass storage controller connected to the bus 410. The mass storage device 412 and its associated computer-readable media provide non-volatile storage for the computer architecture 400. Although the description of computer-readable media contained herein refers to a mass storage device, it should be appreciated by those skilled in the art that computer-readable media can be any available computer-readable storage media or communication media that can be accessed by the computer architecture 400.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 400 may operate in a networked environment using logical connections to remote computers through the network 420. The computer architecture 400 may connect to the network 420 through a network interface unit 422 connected to the bus 410. The computer architecture 400 also may include an input/output controller 424 for receiving and processing input from a number of other devices, including a keyboard, mouse, touch, or electronic stylus or pen. Similarly, the input/output controller 424 may provide output to a display screen, a printer, or other type of output device.

It should be appreciated that the software components described herein may, when loaded into the processing unit(s) 402 and executed, transform the processing unit(s) 402 and the overall computer architecture 400 from a general-purpose computing system into a special-purpose computing system customized to facilitate the functionality presented herein. The processing unit(s) 402 may be constructed from any number of transistors or other discrete circuit elements, which may individually or collectively assume any number of states. More specifically, the processing unit(s) 402 may operate as a finite-state machine, in response to executable instructions contained within the software modules disclosed herein. These computer-executable instructions may transform the processing unit(s) 402 by specifying how the processing unit(s) 402 transition between states, thereby transforming the transistors or other discrete hardware elements constituting the processing unit(s) 402.

The present disclosure is supplemented by the following example clauses:

Example 1: A method comprising: receiving a resource graph comprising a plurality of nodes and a plurality of edges, wherein the plurality of nodes represents a plurality of computing resources and the plurality of edges represents a plurality of connections between pairs of the plurality of computing resources; applying a plurality of category criteria of a plurality of coloring system criteria to the plurality of nodes to identify a plurality of categorized nodes of a plurality of coloring systems, wherein at least some of the plurality of nodes are included in categorized nodes of two or more of the plurality of coloring systems; labeling the plurality of categorized nodes with a plurality of distinct colors; identifying a path comprising two or more of the plurality of nodes; computing a plurality of coloring system scores based on whether a beginning node of the path and an end node of the path have different colors in the plurality of coloring systems; aggregating the plurality of coloring system scores into an aggregate coloring system score; determining that the aggregate coloring system score exceeds a defined aggregate coloring system score threshold; and performing a security operation on a computing resource associated with the path.

Example 2: The method of Example 1, wherein an individual coloring system of the plurality of coloring systems categorizes computing resources by business unit, computing environment, level of enabled security features, organization, domain, or content classification.

Example 3: The method of Example 1, wherein one of the plurality of coloring systems categorizes computing resources into a development environment, a test environment, or a production environment.

Example 4: The method of Example 1, wherein the path comprises a node that is not assigned a color from at least one of the plurality of coloring systems.

Example 5: The method of Example 1, wherein an individual edge between a pair of nodes represents a lateral attack step that an attacker may make between a corresponding pair of computing resources during a cyberattack.

Example 6: The method of Example 1, wherein an individual coloring system score is greater when the path begins and ends at nodes of different colors of a corresponding coloring system.

Example 7: The method of Example 1, wherein the plurality of coloring system scores are weighted differently when aggregating them into the aggregate coloring system score.

Example 8: A system comprising: a processing unit; and a non-transitory computer-readable storage medium having computer-executable instructions stored thereupon, which, when executed by the processing unit, cause the processing unit to: receive a resource graph comprising a plurality of nodes and a plurality of edges, wherein the plurality of nodes represents a plurality of computing resources and the plurality of edges represents a plurality of connections between pairs of the plurality of computing resources; apply a plurality of category criteria of a plurality of coloring system criteria to the plurality of nodes to identify a plurality of categorized nodes of a plurality of coloring systems, wherein at least some of the plurality of nodes are included in categorized nodes of two or more of the plurality of coloring systems; label the plurality of categorized nodes with a plurality of distinct colors; identify a path comprising two or more of the plurality of nodes; compute a plurality of coloring system scores based on a number of times the path crosses-colors in the plurality of coloring systems; aggregate the plurality of coloring system scores into an aggregate coloring system score; determine that the aggregate coloring system score exceeds a defined aggregate coloring system score threshold; and perform a security operation on a computing resource associated with the path.

Example 9: The system of Example 8, wherein aggregating the plurality of coloring system scores comprises adding the plurality of coloring system scores.

Example 10: The system of Example 8, wherein the security operation sends a security alert describing a poor security posture of at least one computing resource represented by a node of the path, wherein the security alert identifies at least one coloring system for which the beginning node of the path and the end node of the path have different colors.

Example 11: The system of Example 8, wherein the security operation automatically enables or increases a security feature of at least one computing resource represented by a node of the path.

Example 12: The system of Example 8, wherein at least one computing resource represented by a node of the path is determined to be involved in a cyberattack, and wherein the security operation comprises sending a security alert identifying the path as a possible vector for the cyberattack.

Example 13: The system of Example 8, wherein the beginning node of the path and the end node of the path have the same colors in the plurality of coloring systems, wherein the instructions further cause the processing unit to: identify the path as non-suspicious.

Example 14: The system of Example 8, wherein nodes are categorized by applying a category criteria to node properties.

Example 15: A non-transitory computer-readable storage medium having encoded thereon computer-readable instructions that when executed by a processing unit causes a system to: receive a resource graph comprising a plurality of nodes and a plurality of edges, wherein the plurality of nodes represents a plurality of computing resources and the plurality of edges represents a plurality of connections between pairs of the plurality of computing resources; apply a plurality of category criteria of a plurality of coloring system criteria to the plurality of nodes to identify a plurality categorized nodes of a plurality of coloring systems, wherein a category criteria of the plurality of category criteria is applied to a node of the plurality of nodes by determining that one or more properties of the node of the plurality of nodes meet a defined criteria, and wherein at least some of the plurality of nodes are included in categorized nodes of two or more of the plurality of coloring systems; label the plurality of categorized nodes with a plurality of distinct colors; identify a path comprising two or more of the plurality of nodes; compute a plurality of coloring system scores based on whether a beginning node of the path and an end node of the path have different colors in the plurality of coloring systems; weight the plurality of coloring system scores with a plurality of weights. add the plurality of coloring system scores into an aggregate coloring system score; determine that the aggregate coloring system score exceeds a defined aggregate coloring system score threshold; and perform a security operation on a computing resource associated with the path.

Example 16: The computer-readable storage medium of Example 15, wherein one of the plurality of coloring system scores of one of the plurality of coloring systems is diminished in response to a determination that at least a defined number or percentage of paths begin and end with nodes of different colors in the one of the plurality of coloring systems.

Example 17: The computer-readable storage medium of Example 15, wherein individual coloring system scores are increased when the path crosses coloring systems.

Example 18: The computer-readable storage medium of Example 15, wherein the instructions further cause the system to: select the security operation based on a particular coloring system or a particular combination of coloring systems for which the beginning node of the path and the end node of the path have different colors.

Example 19: The computer-readable storage medium of Example 15, wherein the instructions further cause the system to: determine that the path violates a precondition of an organization, wherein the security operation comprises sending an alert identifying computing resources that violate the precondition.

Example 20: The computer-readable storage medium of Example 19, wherein the security operation automatically performs a disruption that mitigates the violation of the precondition after the disruption has not been performed manually within a defined amount of time.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a resource graph comprising a plurality of nodes and a plurality of edges, wherein the plurality of nodes represents a plurality of computing resources and the plurality of edges represents a plurality of connections between pairs of the plurality of computing resources;
applying a plurality of category criteria of a plurality of coloring system criteria to the plurality of nodes to identify a plurality of categorized nodes of a plurality of coloring systems, wherein at least some of the plurality of nodes are included in categorized nodes of two or more of the plurality of coloring systems;
labeling the plurality of categorized nodes with a plurality of distinct colors;
identifying a path comprising two or more of the plurality of nodes;
computing a plurality of coloring system scores based on whether a beginning node of the path and an end node of the path have different colors in the plurality of coloring systems;
aggregating the plurality of coloring system scores into an aggregate coloring system score;
determining that the aggregate coloring system score exceeds a defined aggregate coloring system score threshold; and
performing a security operation on a computing resource associated with the path.

2. The method of claim 1, wherein an individual coloring system of the plurality of coloring systems categorizes computing resources by business unit, computing environment, level of enabled security features, organization, domain, or content classification.

3. The method of claim 1, wherein one of the plurality of coloring systems categorizes computing resources into a development environment, a test environment, or a production environment.

4. The method of claim 1, wherein the path comprises a node that is not assigned a color from at least one of the plurality of coloring systems.

5. The method of claim 1, wherein an individual edge between a pair of nodes represents a lateral attack step that an attacker may make between a corresponding pair of computing resources during a cyberattack.

6. The method of claim 1, wherein an individual coloring system score is greater when the path begins and ends at nodes of different colors of a corresponding coloring system.

7. The method of claim 1, wherein the plurality of coloring system scores are weighted differently when aggregating them into the aggregate coloring system score.

8. A system comprising:
a processing unit; and
a non-transitory computer-readable storage medium having computer-executable instructions stored thereupon, which, when executed by the processing unit, cause the processing unit to:
receive a resource graph comprising a plurality of nodes and a plurality of edges, wherein the plurality of nodes represents a plurality of computing resources and the plurality of edges represents a plurality of connections between pairs of the plurality of computing resources;
apply a plurality of category criteria of a plurality of coloring system criteria to the plurality of nodes to identify a plurality of categorized nodes of a plurality of coloring systems, wherein at least some of the plurality of nodes are included in categorized nodes of two or more of the plurality of coloring systems;
label the plurality of categorized nodes with a plurality of distinct colors;
identify a path comprising two or more of the plurality of nodes;
compute a plurality of coloring system scores based on a number of times the path crosses-colors in the plurality of coloring systems;
aggregate the plurality of coloring system scores into an aggregate coloring system score;
determine that the aggregate coloring system score exceeds a defined aggregate coloring system score threshold; and
perform a security operation on a computing resource associated with the path.

9. The system of claim 8, wherein aggregating the plurality of coloring system scores comprises adding the plurality of coloring system scores.

10. The system of claim 8, wherein the security operation sends a security alert describing a poor security posture of at least one computing resource represented by a node of the path, wherein the security alert identifies at least one coloring system for which the beginning node of the path and the end node of the path have different colors.

11. The system of claim 8, wherein the security operation automatically enables or increases a security feature of at least one computing resource represented by a node of the path.

12. The system of claim 8, wherein at least one computing resource represented by a node of the path is determined to be involved in a cyberattack, and wherein the security operation comprises sending a security alert identifying the path as a possible vector for the cyberattack.

13. The system of claim 8, wherein the beginning node of the path and the end node of the path have the same colors in the plurality of coloring systems, wherein the instructions further cause the processing unit to:
identify the path as non-suspicious.

14. The system of claim 8, wherein nodes are categorized by applying a category criteria to node properties.

15. A non-transitory computer-readable storage medium having encoded thereon computer-readable instructions that when executed by a processing unit causes a system to:
receive a resource graph comprising a plurality of nodes and a plurality of edges, wherein the plurality of nodes represents a plurality of computing resources and the plurality of edges represents a plurality of connections between pairs of the plurality of computing resources;
apply a plurality of category criteria of a plurality of coloring system criteria to the plurality of nodes to identify a plurality categorized nodes of a plurality of coloring systems, wherein a category criteria of the plurality of category criteria is applied to a node of the plurality of nodes by determining that one or more properties of the node of the plurality of nodes meet a defined criteria, and wherein at least some of the plurality of nodes are included in categorized nodes of two or more of the plurality of coloring systems;
label the plurality of categorized nodes with a plurality of distinct colors;
identify a path comprising two or more of the plurality of nodes;
compute a plurality of coloring system scores based on whether a beginning node of the path and an end node of the path have different colors in the plurality of coloring systems;
weight the plurality of coloring system scores with a plurality of weights. add the plurality of coloring system scores into an aggregate coloring system score;
determine that the aggregate coloring system score exceeds a defined aggregate coloring system score threshold; and
perform a security operation on a computing resource associated with the path.

16. The computer-readable storage medium of claim 15, wherein one of the plurality of coloring system scores of one of the plurality of coloring systems is diminished in response to a determination that at least a defined number or percentage of paths begin and end with nodes of different colors in the one of the plurality of coloring systems.

17. The computer-readable storage medium of claim 15, wherein individual coloring system scores are increased when the path crosses coloring systems.

18. The computer-readable storage medium of claim 15, wherein the instructions further cause the system to:
select the security operation based on a particular coloring system or a particular combination of coloring systems for which the beginning node of the path and the end node of the path have different colors.

19. The computer-readable storage medium of claim 15, wherein the instructions further cause the system to:
determine that the path violates a precondition of an organization, wherein the security operation comprises sending an alert identifying computing resources that violate the precondition.

20. The computer-readable storage medium of claim 19, wherein the security operation automatically performs a disruption that mitigates the violation of the precondition after the disruption has not been performed manually within a defined amount of time.
